(19) United States
(12) Patent Application Publication
(10) Pub. No.: US 2017/0279788 A1
(43) Pub. Date: Sep. 28, 2017

(54) SECURE REMOTE PASSWORD RETRIEVAL

(71) Applicant: Internet Brands, Inc., El Segundo, CA (US)

(72) Inventors: Joseph Rosenblum, Santa Monica, CA (US); Marjo Fernandez Mercado, Los Angeles, CA (US)

(73) Assignee: Internet Brands, Inc., El Segundo, CA (US)

(21) Appl. No.: 15/083,155

(22) Filed: Mar. 28, 2016

(51) Int. Cl. H04L 29/06

(52) U.S. Cl. CPC H04L 63/083

(57) ABSTRACT

A non-transitory storage medium having stored thereon instructions, the instructions being executable by one or more processors to perform operations including responsive to receiving notification of completion of creation of a secure remote password (SRP) account, prompting a user for a first input corresponding to a username and a second input corresponding to a personal identification number, responsive to receiving the first input and the second input, verifying that the first input and the second input meet all predetermined requirements, responsive to verifying the first input and the second input meet all predetermined requirements and that the first input is not already stored by the non-transitory storage medium, prompting the user for a third input, the third input being a password corresponding to the SRP account, and storing the third input in the non-transitory storage medium is shown.

### FIELD

Embodiments of the disclosure relate to the field of cryptography and password retrieval. More specifically, one embodiment of the disclosure relates to a system for retrieving a password needed for authentication with the secure remote password protocol.

### GENERAL BACKGROUND

Today, security is at the forefront of Internet users' concerns. As stores, banks, credit card companies, health care providers, etc., have turned to the Internet for providing consumers or clients access to services and products, more personal information is being exchanged, stored and accessed over the Internet than ever before. Internet users are routinely creating personal accounts so that the Internet may be used as a vehicle to access personal information (e.g., shopping carts, bank accounts, credit card accounts, health care information, etc.).

As convenient as accessing such information over the Internet may be, security concerns have risen due to hackers or other criminals obtaining personal information by stealing username-password combinations to these personal accounts. For example, hackers commonly attempt to perform man-in-the-middle attacks to steal username-password combinations. Briefly, a man-in-the-middle attack occurs when a hacker secretly intercepts data relayed from a client (e.g., an Internet user) to a server and vice-versa; thus, often obtaining the username and password used to access the client's personal information. The hacker may then use the stolen username and password to access the client's personal information or perform unwanted actions with a personal online account (e.g., purchase thousands of dollars' worth of goods). Several alternative attack methods are well-known which may be used by hackers to steal usernames and passwords (e.g., establishing fake wireless access points, cookie stealing, etc.). Additionally, hackers may use brute force attacks to guess username and password combinations.

Currently, there are several well-known methods that are used to guard against hackers (e.g., cryptography or authentication protocols). In particular, the secure remote password (SRP) protocol is an augmented password-authenticated key agreement (PAKE) protocol that guards against, inter alia, man-in-the-middle attacks. Specifically, authentication using the SRP protocol enables authentication of both the client and server without either party transmitting the password. The SRP protocol involves the initial set-up of an account over a secure network, such as with the use of the HyperText Transfer Protocol Secure (HTTPS), wherein the client provides a username and password to the server and the server implementing the SRP generates and stores a password verifier along with a salt value used in the generation of the password verifier. However, the password is not stored while the username, or representation thereof, is stored. In one embodiment, the password verifier may be generated using a modular exponentiation of a value generated via one or more one-way hash functions. For example, a value, x, may be generated by the server performing a first one-way hash of at least the username and password, and subsequently performing a second one-way hash of the result of the first one-way hash and a salt value. The password verifier may be the result of the modular exponentiation of x. By storing only the username (or representation), the password verifier and the salt value, the server does not store the password, and the password cannot be derived from the password verifier due to the use of one or more one-way hash functions.

After creating an account with the server (e.g., a password verifier was successfully created), a client may begin authentication by providing the server with the username and a first public ephemeral key. The server replies with the salt used when generating the password verifier and a second public ephemeral key. At this stage, the server may generate a session key and the client may generate a session key, each party using at least one or more one-way hash functions. It should be noted that during authentication, the client never sends the password to the server. Once the client has generated a session key, the client transmits the client-generated session key (or proof thereof) to the server and, if the server verifies that the client-generated session key matches the server-generated session key (or proofs thereof), the server may transmit the server-generated session key (or proof thereof) to the client so that the client may verify the two session keys match (or proofs thereof).

As should be understood from the discussion of the methodology of the SRP protocol, the server implementing the SRP does not store the password and is unable to recover the password from the password verifier. Thus, if the client generates a proof of the session key that does not match the proof of the session key generated by the server, the server is unable to authenticate the user. Therefore, although highly secure, one disadvantage of the SRP is the danger of a client being unable to authenticate with the server and forfeiting the online account that utilized the SRP.

### BRIEF DESCRIPTION OF THE DRAWINGS

Embodiments of the disclosure are illustrated by way of example and not by way of limitation in the figures of the accompanying drawings, in which like references indicate similar elements and in which:

FIG. 1 is an exemplary block diagram of a SRP account on a first server and a password retrieval system on a second server.

FIG. 2 is an exemplary block diagram of multiple SRP accounts on one or more servers of a first set of servers and a password retrieval system on a server of a second set of servers.

FIG. 3 is an exemplary illustration of a website instructing a user to register with a password retrieval system following registration of a SRP account.

FIG. 4A is an exemplary illustration of a website instructing a user that he or she is being automatically redirected to a password retrieval system.

FIG. 4B is an exemplary illustration of a website displaying a first step in registering with the password retrieval system.

FIG. 4C is an exemplary illustration of a website displaying a second step in registering with the password retrieval system.

FIG. 4D is an exemplary illustration of a website upon completion of registration with the password retrieval system.

FIG. 5 is an exemplary illustration of a website instructing a user that the password entered was incorrect.

FIG. 6A is an exemplary illustration of a website instructing a user that the password entered was incorrect.

FIG. 6B is an exemplary illustration of a website including a textbox for receipt of a username and a textbox for receipt of a PIN.

FIG. 6C is an exemplary illustration of a website including icons indicating the voice recordings associated with the entered username-PIN combination.

FIG. 7 is an exemplary embodiment of a logical representation of a password retrieval system.

### DETAILED DESCRIPTION

Various embodiments of the disclosure are directed to a password retrieval system that creates an account for a user and stores one or more passwords relating to a secure remote password (SRP) account. The password retrieval system may be utilized by a user associated with a SRP account (e.g., the user has previously created a SRP account) to store a password corresponding to the SRP account, or a hint to the password corresponding to the SRP account. As was discussed above, usernames and passwords are not stored for SRP accounts. Therefore, once a user forgets the username-password combination to the SRP account, the user is no longer able to access the SRP account as the username and password are both unrecoverable. However, by storing the password, or a password hint, the password retrieval system enables users with an SRP account to access the password for the SRP account using separate identifying information (e.g., phone number and a four-digit personal identification number (PIN)).

In one embodiment, upon completing registration with a SRP system and creating a SRP account (for example, via the Internet), the user may be automatically directed to a secure website for the password retrieval system. The password retrieval system prompts the user for a username (e.g., a phone number) and a PIN (e.g., four digits). Upon determining the username has not been used in a username-PIN combination stored in the password retrieval system database, the password retrieval system creates an account for the user. The user is then prompted to input a password (e.g., corresponding to the SRP account). The password may be input in one or more ways, examples of which may include, but are not limited or restricted to, audio input, text input, hand/finger gesture(s) input via a trackpad, etc. Upon completion of the registration, the password retrieval system may automatically direct the user back to the SRP account (e.g., closing the secure webpage of the password retrieval system).

### I. Terminology

In the following description, certain terminology is used to describe features of the invention. For example, in certain situations, the term “logic” and “component” are representative of hardware, firmware or software that is configured to perform one or more functions. As hardware, a component (or logic) may include circuitry having data processing or storage functionality. Examples of such circuitry may include, but are not limited or restricted to a hardware processor (e.g., microprocessor with one or more processor cores, a digital signal processor, a programmable gate array, a microcontroller, an application specific integrated circuit “ASIC,” etc.), a semiconductor memory, or combinatorial elements.

Alternatively, the component (or logic) may be software, such as executable code in the form of an executable application, an Application Programming Interface (API), a subroutine, a function, a procedure, an applet, a servlet, a routine, source code, object code, a shared library/dynamic load library, or one or more instructions. The software may be stored in any type of a suitable non-transitory storage medium, or transitory storage medium (e.g., electrical, optical, acoustical or other form of propagated signals such as carrier waves, infrared signals, or digital signals). Examples of non-transitory storage medium may include, but are not limited or restricted to a programmable circuit; semiconductor memory; non-persistent storage such as volatile memory (e.g., any type of random access memory “RAM”); or persistent storage such as non-volatile memory (e.g., read-only memory “ROM,” power-backed RAM, flash memory, phase-change memory, etc.), a solid-state drive, hard disk drive, an optical disc drive, or a portable memory device. As firmware, the executable code may be stored in persistent storage.

The term “computing device” should be construed as electronics with the data processing capability and/or a capability of connecting to any type of network, such as a public network (e.g., Internet), a private network (e.g., a wireless data telecommunication network, a local area network “LAN”, etc.), or a combination of networks. Examples of a computing device may include, but are not limited or restricted to, the following: a server, an endpoint device (e.g., a laptop, a smartphone, a tablet, a desktop computer, a netbook, a medical device, or any general-purpose or special-purpose, user-controlled electronic device); a mainframe; a router; or the like.

A “message” generally refers to information transmitted in one or more electrical signals that collectively represent electrically stored data in a prescribed format. Each message may be in the form of one or more packets, frames, HTTP-based transmissions, or any other series of bits having the prescribed format.

The term “computerized” generally represents that any corresponding operations are conducted by hardware in combination with software and/or firmware.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

### II. Secure Remote Password Account with Password Retrieval System

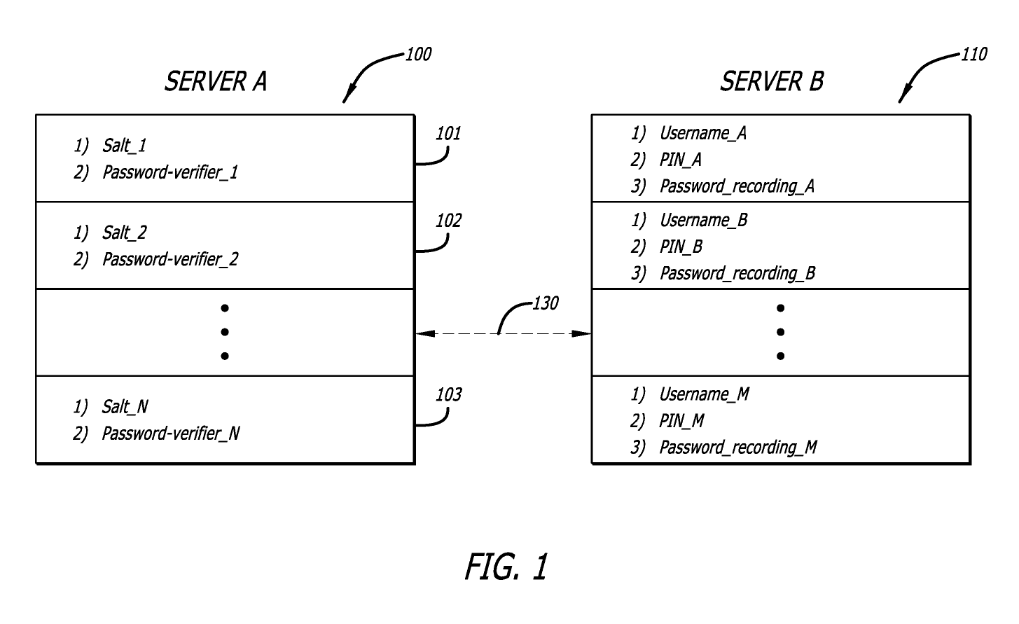

Referring to FIG. 1, an exemplary block diagram of a SRP account on a first server (e.g., Server A) and a password retrieval system on a second server (e.g., Server B) is shown. Herein, the server A 100 includes one or more accounts and utilizes SRP for authentication (herein, the accounts stored on the server A 100 may be referred to as “SRP accounts”). The server A 100 is shown to include a plurality of accounts 101-103; however, the server A 100 is not limited to three accounts but may include more or less than three accounts. An account, for example, account 101, includes the information stored for the account on the server A 100 that enables the server A 100 to authenticate the client to which the account 101 corresponds. Specifically, as was discussed above, the server A 100 may store, for each account, a salt value and a password verifier. For example, the account 101 stored on the server A 100 includes the salt_1 and the password_verifier_1. As discussed above, the username and the password corresponding to the account 101 are not stored and neither are recoverable using the password_verifier_1.

The server B 110 is shown to include a plurality of accounts 111-113; however, the server B 110 is not limited to three accounts but may include more or less than three accounts. The server B 110 is associated with the password retrieval system and includes accounts that enable a user to retrieve a password. Retrieval of a password may include, but is not limited or restricted to, listening to an audio recording of the password, listening to an audio recording of a “hint” of the password, etc. Additionally, as will be discussed below, optionally, notifications may be transmitted via transmission medium 130 between the server A 100 and the server B 110 to notify the server B 110 that an SRP account was created and/or to notify the server A 100 that a password retrieval account was created.

For example, the SRP account 101 and the password retrieval system account 111 may correspond to a first user. When the first user forgets the password corresponding to the SRP account 101, the first user may utilize the password retrieval system to retrieve the password corresponding to the SRP account 101. As will be discussed below, there are numerous ways in which the first user may access the password retrieval system and retrieve the password to the SRP account 101, for example, via telephone and/or a website. In one embodiment, the first user may call a specified telephone number that accesses the server B 110. Upon being accessed by the first user, the server B 110 may prompt the first user for a username and a Personal Identification Number (PIN). The username and PIN may be received by the server B 110 in a variety of methods, examples of which may include, but are not limited or restricted to, a keyboard input, a voice input, a biometric input (e.g., fingerprint and/or retina scanner), etc. In one example, the username may be the number used to call the server B 110. Responsive to receiving input corresponding to the username and PIN, the server B 110 verifies that the received input values match the values for the username and PIN stored therein. Responsive to verifying the received input values corresponding to the username and PIN, the server B 110 may playback the recording of the password associated with the account.

In the embodiment illustrated in FIG. 1, responsive to receiving a request to access an account (e.g., as a result of the first user dialing a specified telephone number), the server B 110 prompts the first user to provide a username and PIN. Responsive to receiving input corresponding to the username and password, the server B 110 verifies whether the received input matches any of the username-PIN combinations stored therein. Responsive to verifying the received input values correspond to a stored username-PIN combination (for example, the username-PIN combination corresponding to the password retrieval account 111), the server B 110 provides the first user with an audio recording of either a password or a “hint” of the password (e.g., corresponding to the SRP account 101).

Alternative methods of conveying the password have been contemplated. For example, the server B 110 may playback a machine translation of the password/hint, or the server B 110 may send a short message service (SMS) text message to the number used to call the server B 110 (an alternative number may be requested by the server B 110 and transmitted to the alternative number). Responsive to providing the first user with the password/hint, the server B 110 may disconnect from the call. Alternatively, the first user may disconnect from the call.

### III. Multiple Secure Remote Password Accounts with Backup System

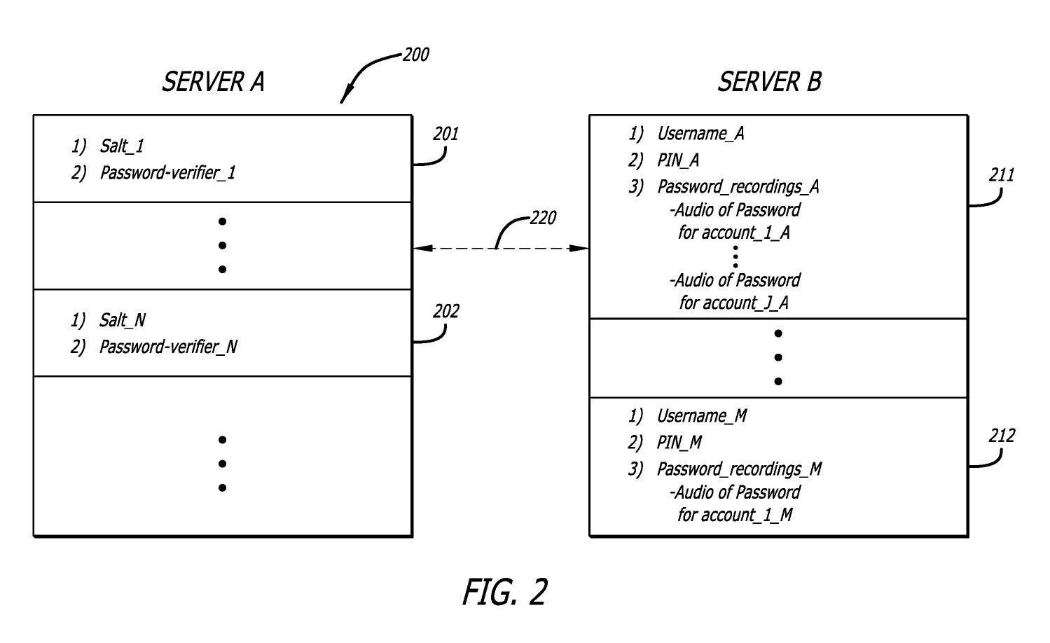

Referring to FIG. 2, an exemplary block diagram of multiple SRP accounts on one or more servers of a first set of servers (e.g., Server A) and a password retrieval system on a server of a second set of servers (e.g., Server B) is shown. Similar to the discussion regarding FIG. 1, the server A 200 includes one or more accounts, e.g., the accounts 201-202, and utilizes SRP for authentication. It should be noted that the server A 200 is not limited to two accounts but may include more or less than two accounts (herein, the accounts stored on the server A 200 may be referred to as “SRP accounts”). As with FIG. 1, the server A 200 may store, for each account, a salt value and a password verifier. As discussed above, the username and the password corresponding to each SRP account are not stored and neither are recoverable using the password_verifier_1.

Furthermore, the server B 210 is shown to include a plurality of accounts 211-212; however, the server B 210 is not limited to two accounts but may include more or less than two accounts. The server B 210 is associated with the password retrieval system and includes accounts that enable a user to retrieve a password. The embodiment shown in FIG. 2 illustrates that a single username-PIN combination may include a plurality of password/hint recordings. Additionally, as with FIG. 1, optionally, notifications may be transmitted via transmission medium 220 between the server A 200 and the server B 210 to notify the server B 210 that an SRP account was created and/or to notify the server A 200 that a password retrieval account was created.

### IV. Associating Secure Remote Password Account(s) with Backup System

As discussed above, one problem with the use of SRP accounts is that the system implementing the SRP account has no way of retrieving a forgotten password. Thus, when a user forgets the password required for accessing the SRP account, the user completely loses the ability to access the account. The inability to access the information may be extremely detrimental for the user. For example, assuming a credit card company implements a SRP account and a user forgets the password associated with the SRP account. The user will subsequently be denied access, thus losing the ability to pay a credit card bill via the Internet. This may result in missed bill payments, which may negatively impact the user's credit score. Alternatively, a user will lose access to information associated with any SRP account to which an associated password is forgotten (e.g., online bank accounts, online stock trading accounts, accounts for online shopping, etc.). Therefore, associating one or more SRP accounts with a password retrieval system provides a company (e.g., a credit card company) with the ability to offer an online account with the security of SRP while also providing the user with the ability to retrieve a forgotten password. Two embodiments of methodologies for associating one or more SRP accounts with a password retrieval system will be discussed below. However, it should be appreciated that several other embodiments have been contemplated and the invention is not limited to the two embodiments discussed below.

1. Telephone Playback Registration Methodology

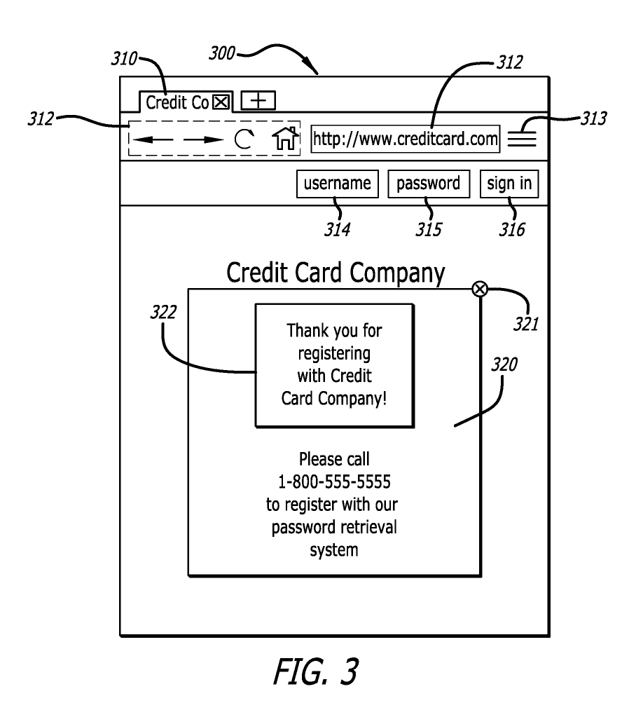

Referring to FIG. 3, an exemplary illustration of a website instructing a user to register with a password retrieval system following registration of a SRP account is shown. A web browser 300 is shown to include at least a first tab 310 associated with a company implementing a SRP system, herein “The Credit Card Company.” The web browser 300 includes the icons 312, an address bar including a Uniform Resource Identifier (URI), e.g., a Uniform Resource Locator (URL) 312, and a settings icon 313. In the embodiment illustrated in FIG. 3, the URL 312 is seen to use an encryption, for example, via the Transport Layer Security, or the Secure Sockets Layer. Specifically, the URL 312 uses a secure protocol such as the “HTTP over TLS” protocol or the “HTTP over SSL” protocol (e.g., both may be referred to as “HTTPS”). The use of HTTPS authenticates the website and the server to which the website is communicating. The use of the HTTPS protocol provides protection against eavesdropping, tampering with transmitted packets and man-in-the-middle attacks. Thus, a user may securely register for a SRP account through the use of the HTTPS protocol.

The website of The Credit Card Company is shown to include a header allowing a user to sign in his or her account via a username text box 314, a password text box 315 and a sign in button 316. Once a user has registered with The Credit Card Company and created a SRP account, the user may access his or her account by signing in using the username text box 314, the password text box 315 and the sign in button 316.

However, if a user has not previously registered with The Credit Card Company and created a SRP account, the user may fill in text boxes providing identification information to The Credit Card Company (e.g., name, address, account number, social security number, etc.) and text boxes for establishing an account (e.g., username and password (not shown). Once a user has successfully created a SRP account, a popup 320 on the website of The Credit Card Company may be displayed to confirm successful registration (e.g., creation of a SRP account). The popup 320 may include a first text box 322 confirming successful registration and additional text instructing the user to call a specified phone number to register with the password retrieval system, as set forth in FIG. 3). The popup 320 may include an exit icon 321 allowing the user to dismiss the popup 320. Thus, the user may call the specified telephone number to initiate the registration with the password retrieval system and dismiss the popup 320 following registration with the password retrieval system or may call the specified telephone number at a subsequent time (e.g., the telephone number shown in FIG. 3 is merely an exemplary number and is not intended to limit the invention). When the user calls the specified telephone number, the user will be prompted to register with the password retrieval system as discussed above with respect to FIGS. 1-2.

Alternatively, or in addition, other embodiments for initiating the registration process have been contemplated, which include, but are not limited or restricted to, the display of a website address to visit, a barcode to scan (e.g., with a mobile device) that will direct the user to a specified website or input a specified telephone number into the user's mobile device (e.g., a smart phone or tablet having the capability to initiate telephone calls), the display of a barcode that will instruct the back-up to automatically initiate a call to the user's telephone number that was entered during the SRP registration process, etc.

2. Internet Playback Registration Methodology

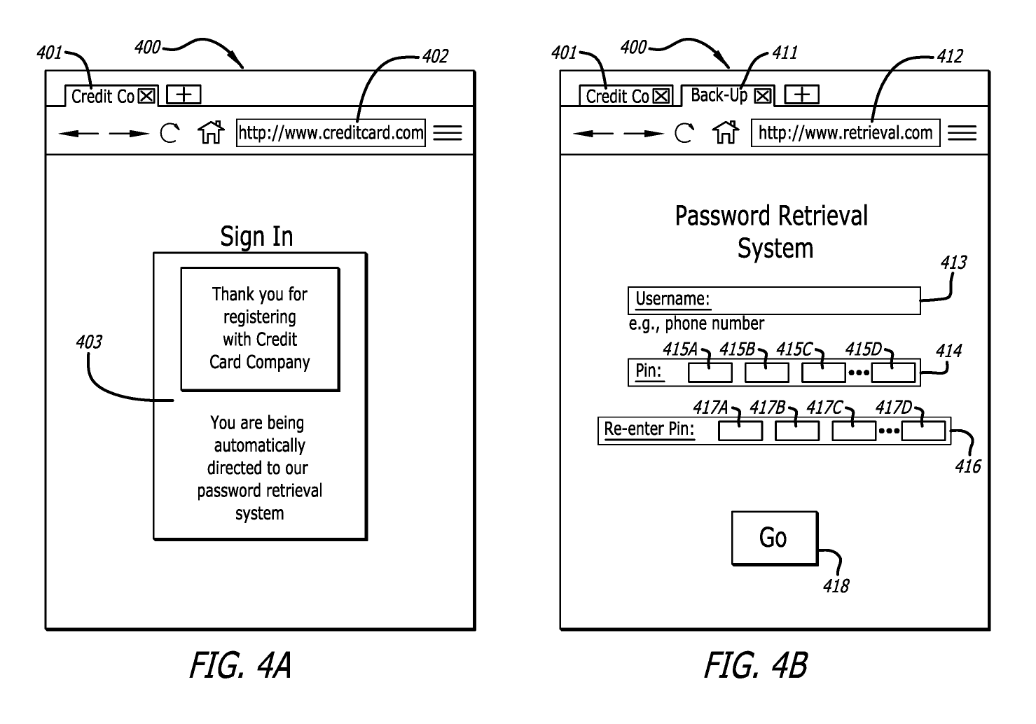

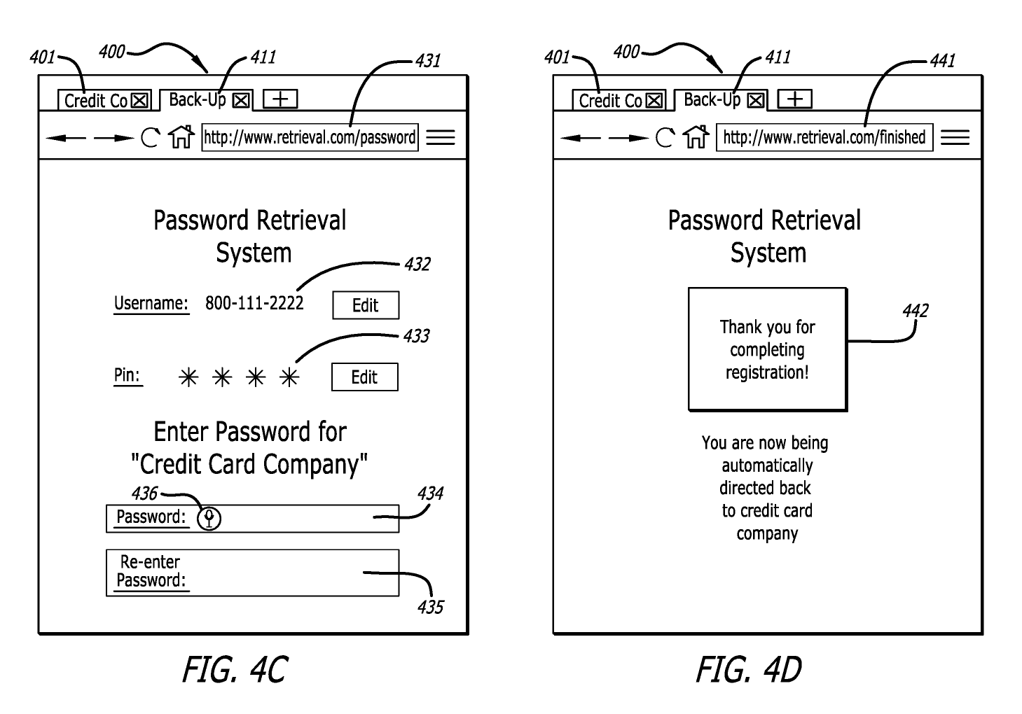

Referring to FIGS. 4A-4D, an illustration of one embodiment of a process of registering with a password retrieval system via the Internet is shown. The process shown in FIGS. 4A-4D illustrates one possible embodiment of how a user may register with the password retrieval system. In the embodiment illustrated in FIGS. 4A-4D, a user is shown to have just completed registration of a SRP account (e.g., herein, with a credit card company) so that the user may access their account with the credit card company via the Internet in a secure manner. Specifically, the process shown includes an automatic redirect of the user to the backup system upon completion of registration of the SRP account.

Referring to FIG. 4A, an exemplary illustration of a website instructing a user that he or she is being automatically redirected to a password retrieval system is shown. A web browser 400 is shown to include at least a first tab 401 associated with a company implementing a SRP system, herein “The Credit Card Company.” The web browser 400 includes, inter alia, an address bar including a URL 402. The URL 402 illustrates that the user has opened a HyperText Transfer Protocol (HTTP) session with “The Credit Card Company.” The website of The Credit Card Company, corresponding to the URL 402, is shown to include a popup 403 that notifies the user he or she is being automatically directed to register with the password retrieval system. In the embodiment illustrated in FIG. 4A, the popup 403 may not include an exit icon (e.g., in contrast to the inclusion of the exit icon 321 as seen in FIG. 3). The lack of an exit icon on the popup 403 may indicate that the user is unable to dismiss the popup 403. Instead, the password retrieval system may automatically close the popup 403 once registration with the password retrieval system is complete. For example, upon completion of storage of a representation of a password with the password retrieval system, the password retrieval system may notify the SRP system that storage has been completed. In one embodiment, the password retrieval system may set a flag locally (e.g., store the flag on a storage device associated with the password retrieval system) for the password retrieval system account upon completion of storage of a representation of a password corresponding to the SRP account. In one embodiment in which multiple passwords are associated with a single password retrieval system account, a flag may be set for each password associated therewith, as will be discussed below. The SRP system may transmit a request message to the password retrieval system to determine whether an account with the password retrieval system has been established for a given user (e.g., whether the completion flag has been set). Based on the response transmitted by the password retrieval system, the SRP system may determine whether registration for the account with the password retrieval system has been completed (e.g., username and PIN have been established and password, or hint, has been recorded).

For example in a first embodiment, a link may be established between the SRP system and the password retrieval system, wherein an identifier of the SRP account may be passed to the password retrieval system in the link. For example, the identifier may be any representation that the SRP system may use to identify the SRP account such as the SRP account name, a numeric string, an alphanumeric string, etc. Such a link may be established through one of several protocols, including but not limited or restricted to, HTTP (e.g., http://password_retrieval_web_site.com/account name), HTTPS, file transfer protocol (FTP), simple mail transfer protocol (SMTP), simple file transfer protocol (SFTP), etc. Additionally, in one embodiment, such a link may be established as a one-time connection (e.g., once the link is established and the exchange of data is completed, the link is torn down and will need to be established again for subsequent interactions between the SRP system and the password retrieval system. Upon completion of registration of an account with the SRP system, the SRP system automatically directs the user to the password retrieval system via the link. The password retrieval system receives input from the user to complete storage of a representation password associated with the SRP account, as discussed below, and upon completion of the storage of the representation of the password, the password retrieval system sets a flag signifying a status of the storage (e.g., success or failure) and automatically directs the user to the SRP system. Upon receiving an indication the user has been redirected back to the SRP system, the SRP system subsequently transmits a request to the password retrieval system to ascertain the status (e.g., value) of the flag associated with the user's password retrieval system account. In one embodiment, the password retrieval system may call a “completion” webpage of the SRP system, which acts at the indication the user is being directed back to the SRP system. Additionally, the status of the flag may be included within the link (e.g., URL) to the completion webpage of the SRP system. Upon receiving a response wherein the status of the flag indicates storage of the password was unsuccessful, the SRP system may redirect the user back to the password retrieval system. When the status of the flag signifies the storage of the representation of the password was successful, the password retrieval system may provide the user with access to the SRP system. Alternatively, the password retrieval system may include the status of the flag associated with the storage of the representation of the password in the direct of the user to the SRP system.

In a second embodiment in which a link is present between the SRP system and the password retrieval system, the SRP system may not perform an automatic direct of the user via the link upon completion of registration of a user account (e.g., allowing the user to complete storage of a representation of a password corresponding to a SRP account with the password retrieval system at a later time) but the password retrieval system may perform an automatic direct of the user to the SRP system via the link upon completion of the storage of a representation of a password.

In one embodiment, a direct or a redirect of a user may refer to directing or redirecting a user's HTTPS session (“user session”). For example, a direct from the SRP system upon completion of registration may result in the SRP system passing identifying information of the user's HTTPS session (e.g., a session token or session identifier (ID)) to the password retrieval system. The password retrieval system may receive input such as a password retrieval system username, a title or “nickname” for the representation of a password corresponding to a SRP account, and a password. Upon storing a representation of the password, the password retrieval system may automatically direct the user session back to the SRP system along with the status of a flag indicating the storage of a representation of a password associated with the user (identified by the session ID) has been completed. Once the password retrieval system redirects the user session back to the SRP system, the user session need not be stored; thus, removing any connection between the SRP system and the password retrieval (e.g., no requirement to store the SRP username).

In a third embodiment, upon receiving login credentials from a user, the SRP system may transmit a request to the password retrieval system requesting a status of a flag signifying the completion of storage of a representation of a password for the SRP username associated with the username included in the request. In such an embodiment, the request transmitted by the SRP system to the password retrieval system may include the SRP username. Upon receiving such a request, the password retrieval system may use the SRP username to index into an entry of a first data structure including the SRP username. For example, in one embodiment, for each SRP account, the password retrieval system may store entries within in a first data structure wherein each entry may include at least: a password retrieval system username; the SRP username; a status flag; and a representation of the password associated with the SRP username (e.g., audio recording, text, etc.). The PIN associated with the password retrieval system username may be stored in the entries of the first data structure or may be stored in a separate, second data structure wherein each entry includes at least the password retrieval system username and the corresponding PIN. For example, referring to FIG. 2, a request including the SRP username included in the login credentials is transmitted to the password retrieval system. The password retrieval system uses the SRP username to index into the entries of the first data structure in order to determine whether a status flag associated with the SRP username indicates the successful storage of a representation of a password for the SRP username.

In yet another embodiment in which no link between the SRP system and the password retrieval system is present, the password retrieval system may notify the SRP system of the completion of registration of a user having an account with the SRP system. For example, upon completion of storage of a representation of a password corresponding to the SRP account, the password retrieval system may automatically send a notification to the SRP system including at least the SRP username to which the password retrieval system account is associated and the status of the flag indicating whether the registration was completed successfully.

Referring to FIG. 4B, an exemplary illustration of a website displaying a first step in registering with a password retrieval system is shown. The web browser 400 is shown to include at least the first tab 401 and a second tab 411, the tab 411 being associated with a password retrieval system. The web browser 400 includes, inter alia, an address bar including a URL 412. The URL 412 illustrates that the user has opened a HTTPS session with the password retrieval system. Specifically, the first HTTPS session is associated with The Credit Card Company and the second HTTPS session is associated with the password retrieval system; thus, the two HTTPS sessions are not connected and do not share data.

The website of the password retrieval system, corresponding to the URL 412, is shown to include a username entry box 413 to receive a proposed username from the user (e.g., a telephone number associated with the user), a first PIN textbox 414 for receiving a PIN and a second PIN textbox 416 for verification of the PIN entered by the user. The PIN textbox 414 may include one or more entry boxes (e.g., 415A-415D), each for receiving a single character (e.g., alphanumeric character). Similarly, the PIN textbox 416 includes the same number of entry boxes (e.g., 417A-417D) as the PIN textbox 414. It is noted that although FIGS. 4B and 4C illustrate four entry boxes, more or less entry boxes may be used. In the alternative, a textbox instead of single character boxes. Additionally, in another embodiment, the PIN may include characters or symbols other than alphanumeric characters. Furthermore, the PIN may be input via a biometric measure (e.g., fingerprint scan or retina scan) or gesture-based (e.g., a gesture via physical contact with a touch-screen or a track pad may be converted into a character string representing the PIN).

Upon receiving a proposed username, a PIN in the PIN textbox 414 and a PIN in the PIN textbox 416, the “Go” button 418 may be activated (e.g., clicked by the user). Responsive to the “Go” button 418 being activated, the password retrieval system may verify that the username is not already associated with a user and verify that the entries in the PIN textbox 414 and the PIN textbox 416 match before proceeding. If the received proposed username is already associated with a user, the password retrieval system may request that the user to enter the PIN associated with the username or enter a username. If the entries in the PIN textbox 414 and the PIN textbox 416 do not match, the password retrieval system may request the user to enter matching entries.

Referring to FIG. 4C, an exemplary illustration of a website displaying a second step in registering with a password retrieval system is shown. As in FIG. 4B, the web browser 400 is shown to include the first tab 401 and the second tab 411, wherein the two HTTP sessions are not connected and do not share data. The website associated with URL 431 displays the username provided (e.g., username 432) but does not display the PIN provided (e.g., PIN 433) for security purposes. The website may enable editing of the username and/or PIN, which may return the user to the website associated with URL 412 as seen in FIG. 4B. The website associated with the URL 431 is seen to include a password input box 434 and a confirmation password input box 435. As was discussed above with respect to the PIN, the password may include characters or symbols other than alphanumeric characters. As discussed above, the password received by the password input boxes 434 and 435 should be the password associated with the SRP account corresponding to the HTTP session open via the website associated with the URL 402 as seen in FIG. 4A.

Furthermore, icon 436 (e.g., representing a microphone) may enable the user to record a voice recording of the password. In one embodiment in which a voice recording is used, the confirmation password input box 435 may remain blank. Alternatively, in another embodiment, when the icon 436 is activated and a password is entered as a voice recording, the confirmation password input box 435 may also receive a voice recording enabling the user to record multiple voice recordings of the password.

Referring to FIG. 4D, an exemplary illustration of a website upon completion of registration with the password retrieval system is shown. As in FIGS. 4B and 4C, the web browser 400 is shown to include the first tab 401 and the second tab 411, wherein the two HTTP sessions are not connected and do not share data. The website associated with URL 441 displays the text 442 confirming that registration with the password retrieval system has been completed and notifies the user that he or she is being automatically direct back to the website of The Credit Card Company (i.e., the website associated with the URL 402). In one embodiment, the user may be directed back to the website associated with the URL 402 by the automatic closer of the tab 411.

### V. Retrieving Forgotten Password

Upon forgetting at least a portion of login credentials (e.g., the password) for a SRP account, a user may utilize the password retrieval system to recover a forgotten password. In one embodiment, responsive to receiving incorrect input from the user, a server implementing the SRP system may instruct a user to call a specific telephone number to access the password retrieval system. Alternatively, responsive to receiving incorrect input from the user, the server implementing the SRP system may automatically direct the user to the password retrieval system (e.g., automatically direct the user to the Internet website of the password retrieval system). In yet another embodiment, the user may visit the password retrieval system password without being automatically directed. Responsive to the user calling a specified telephone number, the password retrieval system may request a PIN, and optionally, a username (e.g., when the username is not necessarily the phone number used to call the password retrieval system). Similarly, responsive to the loading of the password retrieval system website, the password retrieval system may request a username and a PIN (e.g., in the form of textboxes).

Responsive to receiving a username and a PIN, the password retrieval system may determine whether the received username-PIN combination corresponds to an account stored thereon. When the received username-PIN combination corresponds to an account, the password retrieval system presents the user with the one or more password/hint recordings (wherein a recording may be an audio recording, a text input, a hand gesture, e.g., on a trackpad, etc.).

1. Telephone Playback Retrieval Methodology

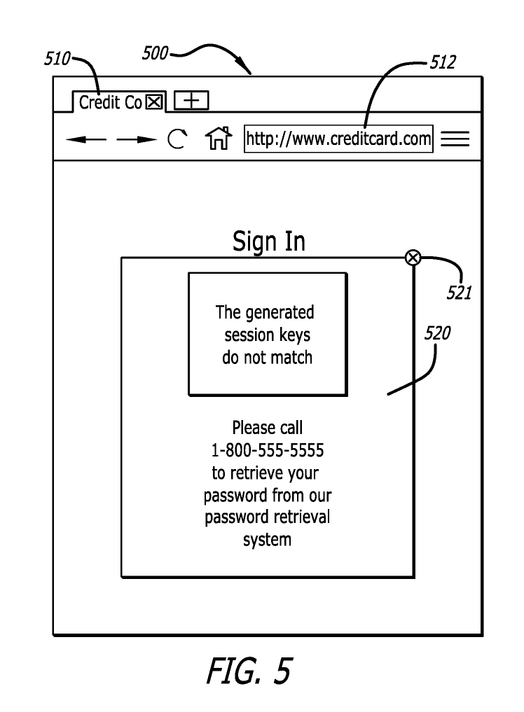

Referring to FIG. 5, an exemplary illustration of a website instructing a user that the password entered was incorrect is shown. A web browser 500 is shown to include at least a first tab 510 associated with a company implementing a SRP system, herein “The Credit Card Company.” The web browser 500 includes, inter alia, an address bar including a URL 512. As discussed above, the URL 512 uses a secure protocol connection, such as, for example, HTTPS. Once a user has created a SRP account with The Credit Card Company, as discussed above with respect to FIGS. 3-4D, the user may attempt to sign in to the account. When the client generates a proof of the session key that differs from the proof of the session key generated by the SRP server (e.g., the SRP server received an incorrect username as input which leads to the generation of mismatching proof of session keys), the website of The Credit Card Company, corresponding to the URL 512, is shown to include a popup 520 that notifies the user that an incorrect password has been received by the system (e.g., entered by the user) match and includes text instructing the user to call a specified phone number to retrieve the correct password using the password retrieval system. The popup 520 may include an exit icon 521 allowing the user to dismiss the popup 520. Thus, the user may call the specified telephone number to retrieve the password and dismiss the popup 520 immediately or may call the specified telephone number at a subsequent time (e.g., the telephone number shown in FIG. 5 is merely an exemplary number and is not intended to limit the invention). When the user calls the specified telephone number, the user will be prompted to enter at least a PIN, and optionally, a username as discussed above with respect to FIGS. 1-2.

2. Internet Playback Retrieval System

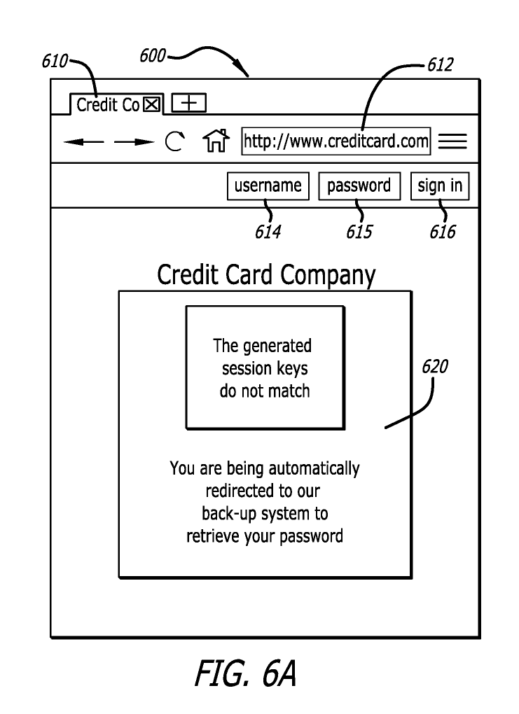

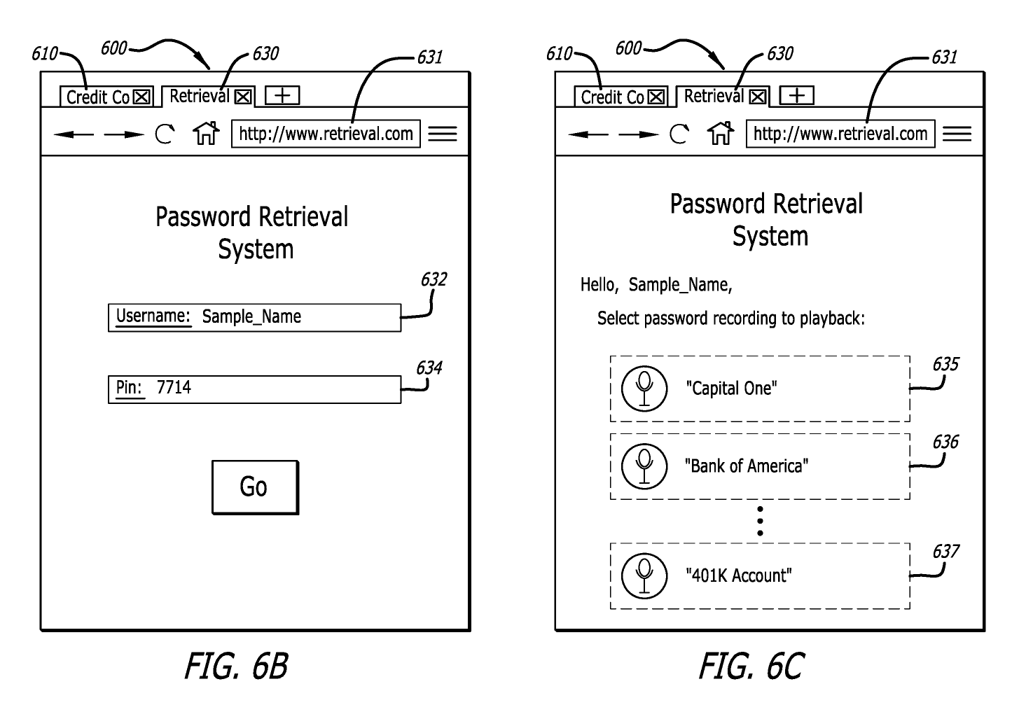

Referring to FIGS. 6A-6C, an illustration of one embodiment of a process of retrieving a password via a password retrieval system using the Internet is shown. The process shown in FIGS. 6A-6C illustrates one possible embodiment of how a user may retrieve a password with the password retrieval system and is not intended to limit the invention. Referring to FIG. 6A, an exemplary illustration of a website instructing a user that the password entered was incorrect is shown. A web browser 600 is shown to include a first tab 610 associated with The Credit Card Company, which is implementing an SRP system. The web browser 600 includes, inter alia, an address bar including a URL 612. Once a user has created an account with the SRP system, as discussed above, the user may attempt to sign in and view the SRP account, such that the user (e.g., the client) generates a client session key and the SRP system (e.g., the server) generates a server session key. When the user generated session key differs from the SRP server generated session key, the SRP system may prompt the user to re-enter the username and/or password so that a second attempt at generating matching session keys may be performed. When the user generated session key differs from the SRP server generated session key (possibly for a second time), the SRP server may present the user, via the web browser 600, with a popup 620 that notifies the user that the password entered was incorrect and includes text instructing the user that he or she is being automatically redirected to the password retrieval system to retrieve the correct password.

Referring to FIG. 6B, an exemplary illustration of a website including a textbox 632 for receipt of a username and a textbox 634 for receipt of a PIN is shown. The web browser 600 is shown to include at least the first tab 610 and a second tab 630. The web browser 600 includes, inter alia, an address bar including a URL 631. Once a user has successfully entered a correct username-PIN combination, the password retrieval system may present a confirmation that the correct username-PIN combination was entered (e.g., as illustrated in FIG. 6C with the text, “Hello, Sample Name”).

Referring now to FIG. 6C, an exemplary illustration of a website including icons indicating the voice recordings associated with the entered username-PIN combination is shown. The web browser 600 is shown to include at least the first tab 610 and the second tab 630. The web browser 600 includes, inter alia, an address bar including the URL 631. Responsive to receiving a correct username-PIN combination, the password retrieval system presents the voice recordings 635-637 associated with the username-PIN combination. In the embodiment illustrated in FIG. 6C, three voice recordings 635-637 are shown to be associated with the username-PIN combination entered. In an embodiment in which multiple accounts (one or more being SRP) are linked to a single username-PIN combination in the password retrieval system, each voice recording may also have a title or “nickname” (e.g., “Capital One” 365, “Bank of America” 366, or “401K Account” 367) to aid the user in remembering to which account each voice recording belongs. In one embodiment, the title or “nickname” for each password is a representation of the SRP account username to which the password correspond (e.g., a one-way hash of the username).

Finally, responsive to receiving a selection (e.g., activation of a microphone icon associated with a voice recording), the password retrieval system may play the audio recording of the password corresponding to the selected voice recording. For example, responsive to receiving an activation of the microphone associated with the nickname, “Bank of America,” 365 the password retrieval system plays the audio recording of the password corresponding to the nickname “Bank of America” 365. In one embodiment, the password retrieval system may receive a first selection, play the audio corresponding to the first selection, receive a second selection and play the audio corresponding to the second selection.

### VI. Logical Representation

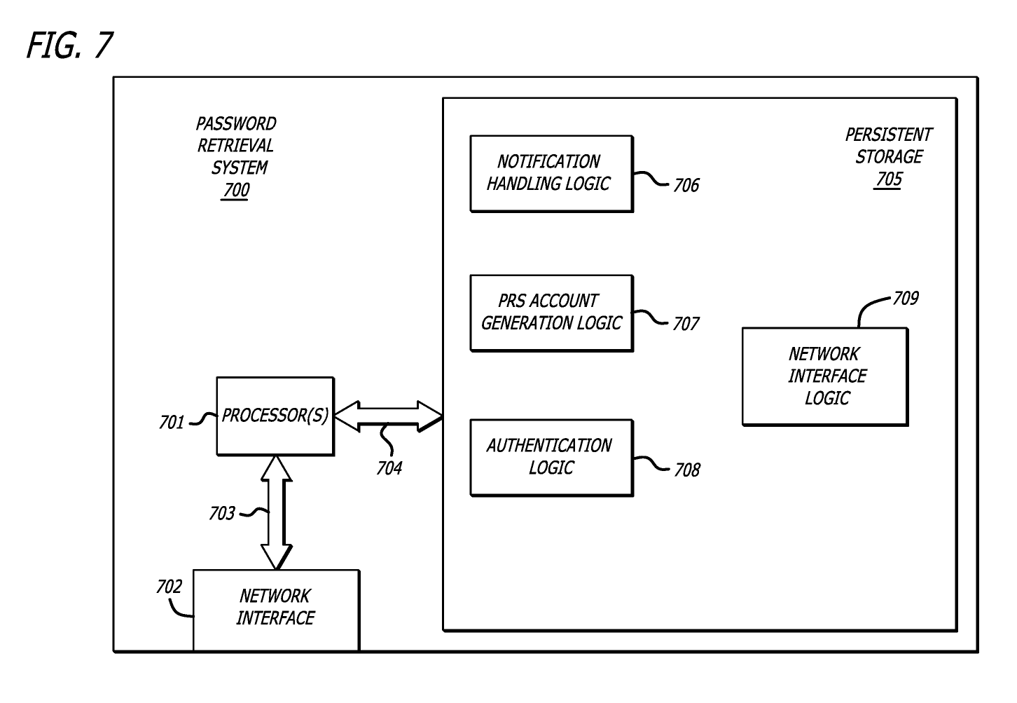

Referring to FIG. 7, an exemplary embodiment of a logical representation of a password retrieval system is shown. The password retrieval system 700 may comprise a server device having one or more processors 701 that are coupled to a network interface 702 via a first transmission medium 703. The network interface 703 and the network interface logic 709 enable communication with one or more the endpoint devices (e.g., mobile smart phone, tablet, laptop, desktop computer, etc.) via the Internet. According to one embodiment of the disclosure, the network interface 702 may be implemented as a physical interface including one or more ports for wired connectors. Additionally, or in the alternative, the communication interface logic 1402 may be implemented with one or more radio units for supporting wireless communications with other electronic devices. The network interface logic 709 may be software, hardware or a combination thereof that provides instructions for handling incoming and outgoing network traffic.

The processor(s) 701 is further coupled to persistent storage 705 via a second transmission medium 704. According to one embodiment of the disclosure, persistent storage 705 may include (a) the notification handling logic 706, (b) a password retrieval system account generation logic 707, (d) an authentication logic 708, and (e) the network interface logic 709. Of course, when implemented as hardware, one or more of these logic units could be implemented separately from each other.

The optional notification handling logic 706 receives notifications from the system or server implementing the SRP. For example, responsive to the completion of creation of a SRP account, the server or system may automatically transmit a notification message to the password retrieval system notifying the password retrieval system of the newly created SRP account. The notification handling logic 706 receives the notification message and relays the content to the password retrieval system account generation logic 707. In one embodiment in which the system implementing SRP and the password retrieval system are implemented with hardware and software having an Internet interface (e.g., a website), the notification handling logic 706 is present to receive notifications from the system implementing the SRP that are transmitted automatically upon creation of an SRP account. In an alternative embodiment, the notification handling logic 706 may not be present when the password retrieval system does not include an Internet interface but instead interfaces with users via a telephone system.

In one embodiment in which the system implementing SRP and the password retrieval include an Internet interface as discussed above, the password retrieval system account generation logic 707 handles password retrieval system account generation by receiving input corresponding to a username and a PIN (e.g., through input boxes as illustrated in FIG. 4B). Responsive to receiving input corresponding to a username and a PIN, the password retrieval system account generation logic 707 verifies that the username and PIN both meet all requirements set forth for each (e.g., only numeric characters included in the PIN) and verifies that the username is not currently being used. Responsive to determining the username and PIN meet all requirements and that the username is not currently being used, the password retrieval system account generation logic 707 prompts the user for input corresponding to a SRP password. For example, the password retrieval system account generation logic 707 may prompt the user for an audio input as illustrated in FIG. 4C. Responsive to receiving input corresponding to the password, the password retrieval system account generation logic 707 subsequently stores the password along with the username and PIN.

In an alternative embodiment in which the password retrieval system is implemented via a telephone line, the password retrieval system account generation logic 707 may prompt the user via audio commands for a username and a PIN. As above, responsive to determining the username and PIN meet all requirements and that the username is not currently being used, the password retrieval system account generation logic 707 may prompt the user via audio commands for input corresponding to a SRP password. Responsive to receiving input corresponding to the password, the password retrieval system account generation logic 707 subsequently stores the password along with the username and PIN.

The authentication logic 708 handles authentication of the user prior to providing the user with a stored password. Responsive to receiving a notice that a user has called the telephone line of the password retrieval system or has requested the webpage of the password retrieval system, the authentication logic 708 prompts the user for a username-PIN combination either via voice commands over the telephone line or via input boxes (as illustrated in FIG. 6B). Responsive to receiving a username-PIN combination, the authentication logic 708 determines whether the received username-PIN combination matches a username-PIN combination stored in the password retrieval system (e.g., a portion of the password retrieval system may be a storage device, such as a portion of the persistent storage 705, structured as, for example, a relational database). In one embodiment, responsive to determining the received username-PIN combination matches a username-PIN combination stored in the password retrieval system, the authentication logic 708 provides the user the password associated with the username-PIN combination.

In a second embodiment, in which multiple passwords are associated with a single username-PIN combination, upon determining a received username-PIN combination corresponds to multiple passwords, the password retrieval system may prompt the user for the desired password. For example, as illustrated in FIG. 6C, the password retrieval system may provide the user with a plurality of visual options wherein each option corresponds to a stored password (e.g., “Capital One”, “Bank of America”, etc.). Alternatively, when a telephone line is used by the user to access the password retrieval system storing multiple passwords, the password retrieval system may provide an audio recitation of the titles or “nicknames” of each password. In one embodiment, at the time of registration (or addition of a new password or change of a password) each password may be associated with a title or nickname entered by the user.

In the foregoing description, the invention is described with reference to specific exemplary embodiments thereof. It will, however, be evident that various modifications and changes may be made thereto without departing from the broader spirit and scope of the invention as set forth in the appended claims.

What is claimed is:

1. A non-transitory storage medium having stored thereon instructions, the instructions being executable by one or more processors to perform operations comprising:
responsive to receiving notification of completion of creation of a secure remote password (SRP) account, prompting a user for a first input corresponding to a username and a second input corresponding to a personal identification number;
responsive to receiving the first input and the second input, verifying that the first input and the second input meet all predetermined requirements;
responsive to verifying the first input and the second input meet all predetermined requirements and that the first input is not already stored by the non-transitory storage medium, prompting the user for a third input, the third input being a password corresponding to the SRP account; and
storing the third input in the non-transitory storage medium.

2. The storage medium of claim 1, wherein, prompting the user for the first input and the second input is done through the use of presenting a first entry box corresponding to the first input and a second entry box corresponding to the second input.

3. The storage medium of claim 1, wherein the first input and the second input are audio inputs.

4. The storage medium of claim 1, wherein the username is different than a second username corresponding to the SRP account.

5. The storage medium of claim 1, wherein the third input is audio data.

6. The storage medium of claim 1, wherein the third input includes alphanumeric text.

7. The storage medium of claim 1, wherein the notification of the completion of the creation of the SRP account is received via a Uniform Resource Identifier (URI) activated by a SRP system corresponding to the SRP account.

8. The storage medium of claim 7, wherein the URI includes an identifier of the SRP account.

9. The storage medium of claim 8, further comprising:
responsive to storing the third input, activating a second URI, the second URI corresponding to the SRP system and including the identifier of the SRP account.

10. A system for establishing a password retrieval system account, the system comprising:
one or more processors; and
a storage device having stored thereon instruction, the instructions, when executed by the one or more processors, cause the one or more processors to:
responsive to receiving a notification of completion of creation of a secure remote password (SRP) account via a Uniform Resource Indicator (URI), prompt a user for a username, a password and a third input, the URI including an identifier of the SRP account;
storing the username, the password and the third input in the storage device; and
activating a second URI including the identifier of the SRP account to notify a SRP system of a completion of the establishing of the SRP account, the second URI corresponding to the SRP system.

11. The storage medium of claim 10, wherein, prompting the user for the first input and the second input is done through the use of presenting a first entry box corresponding to the first input and a second entry box corresponding to the second input.

12. The storage medium of claim 10, wherein the first input and the second input are audio inputs.

13. The storage medium of claim 10, wherein the personal identification number consists of alphanumeric text.

14. The storage medium of claim 10, wherein the third input is audio data.

15. The storage medium of claim 10, wherein the third input includes alphanumeric text.

16. A method for establishing a password retrieval system account, the system comprising:
responsive to receiving a notification of completion of creation of a secure remote password (SRP) account via a Uniform Resource Indicator (URI), prompting a user for a username via a first entry box, a password via a second entry box and a third input via a third entry box, the URI including an identifier of the SRP account and the prompting performed on a display screen of an endpoint device;
storing the username, the password and the third input in a non-transitory storage device; and
activating a second URI including the identifier of the SRP account to notify a SRP system of a completion of the establishing of the SRP account, the second URI corresponding to the SRP system.

17. The method of claim 16, further comprising:
prompting the user for a name for the third input in the non-transitory storage device; and
storing the name for the third input.

18. The method of claim 16, wherein the first input and the second input are audio inputs.

19. The method of claim 16, wherein the personal identification number consists of alphanumeric text.

20. The method of claim 16, wherein the third input is audio data.
